(19) United States
(12) Patent Application Publication
(10) Pub. No.: US 2026/0049883 A1
(43) Pub. Date: Feb. 19, 2026

(54) LEAK DETECTION SYSTEMS AND METHODS

(71) Applicant: Lindsay Corporation, Omaha, NE (US)

(72) Inventor: Jamey Hilleary, Omaha, NE (US)

(21) Appl. No.: 19/032,178

(22) Filed: Jan. 20, 2025

Related U.S. Application Data
(60) Provisional application No. 63/683,526, filed on Aug. 15, 2024.

(51) Int. Cl. G01M 3/16; G08B 21/18

(52) U.S. Cl. CPC G01M 3/16; G08B 21/182

(57) ABSTRACT

A leak detection system that requires no externally powered sensors or SCADA communication systems and that provides alerts and other sensor data to users via a web-enabled portal includes at least one sensor; a sensor monitor; and a web-enabled remote computer.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/683526; titled “TOXIC GAS EMISSIONS AND LIQUID HYDROCARBONS LEAK DETECTION MONITORING SYSTEMS”; and filed Aug. 15, 2024. The Provisional Application is hereby incorporated by reference, in its entirety, into the current patent application.

### BACKGROUND OF THE INVENTION

Pipelines, tanks, valves, and other gas or liquid carrying/storing devices are often monitored for leaks. Many current leak detection systems require sensors that must be externally powered and SCADA-based communication systems for transmitting sensor data to remote control centers. Providing electrical connections to sensors and SCADA communications is impractical and/or too expensive for many remote locations. Current leak detection systems send alerts for detected leaks to remote control centers where they are eventually conveyed to appropriate personnel, but such alerts often aren't forwarded soon enough and/or don't provide enough information for the personnel to take appropriate actions without further investigations.

### SUMMARY OF THE INVENTION

Embodiments of the current invention address at least some of the above-mentioned problems and provide a distinct advance in the art of leak detection systems and methods. Particularly, embodiments of the invention provide a leak detection system that requires no externally powered sensors or SCADA communication systems and that provides alerts and other sensor data directly to critical personnel via a web-enabled portal that permits users to select how alerts are communicated, sampling intervals, reporting frequencies, alarm thresholds, and other monitoring parameters.

A leak detection system constructed in accordance with an embodiment of the invention broadly comprises at least one sensor; a sensor monitor; and a web-enabled remote computer. The leak detection system is particularly suited for detecting liquid and/or gas leaks in hydrocarbon facilities but may be used in any industry or application.

The sensor may be a liquid sensor, a gas sensor, a level sensor, or any other sensor that can sense the presence of a liquid or gas, the level of a liquid or gas, or any other parameter that may indicate a liquid or gas leak. The sensor may be placed anywhere, such as near a monitored pipe, tank, etc., and does not need a separate source of power as discussed below.

The sensor monitor powers and monitors the sensor and wirelessly communicates with the remote computer. In one embodiment, the sensor monitor periodically sends an excitation signal to the sensor, receives a return sensor signal that is proportional to an amount of gas or liquid sensed by the sensor, and transmits data representative of the sensor signal to the remote computer. In some embodiments, the sensor monitor receives user-specified alarm threshold values from the remote computer and only transmits sensor signals to the remote computer when the sensed gas or liquid exceeds the alarm threshold values.

The remote computer wirelessly communicates with the sensor monitor and provides a web portal that may be accessed by smart phones, personal computers, or other web-enabled user devices. The web portal allows users to monitor pipes, tanks, etc. for liquid or gas leaks and provides “report by exception” monitoring and communication that sends instant text or email alerts to users if leaks are detected. The web portal also allows users to remotely set and adjust monitoring parameters such as alarm thresholds, reporting frequencies, and alert delivery preferences.

In one embodiment, the remote computer receives data representative of the sensor signals from the sensor monitor and converts the sensor signals to logical sensor values such as parts-per-million (PPM), gallons-per-minute (GPM), or other volume per unit of time values so that the sensor monitor can transmit “raw” sensor data and users who access the remote computer are presented with easy to understand logical sensor values. The remote computer may also receive alarm threshold values from users that are in the logical sensor values, convert these logical sensor values to sensor signal values such as volts or amps, and then transmit data representative of the alarm threshold values to the sensor monitor. This shifts processing requirements from the sensor monitor to the remote computer to improve the throughput and decrease the power requirements of the sensors monitor.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a leak detection system constructed in accordance with an embodiment of the invention.

FIG. 2 is a leak detection system constructed in accordance with another embodiment of the invention.

FIG. 3 is a block diagram depicting selected components of a sensor monitor constructed in accordance with embodiments of the invention.

FIG. 4 is a block diagram depicting selected steps in a method of the present invention and/or computer implemented functions in software operating components of the systems of FIG. 1 or 2.

FIG. 5 is a block diagram depicting selected steps in another method of the present invention and/or computer implemented functions in software operating components of the systems of FIG. 1 or 2.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

Leak detection systems and methods in accordance with embodiments of the invention are depicted in the attached drawing figures. The leak detection systems and methods described and illustrated herein are particularly suited for detecting liquid or gas leaks from valves, pipes, tanks, and other components of hydrocarbon facilities, but they may be used in any industry or application.

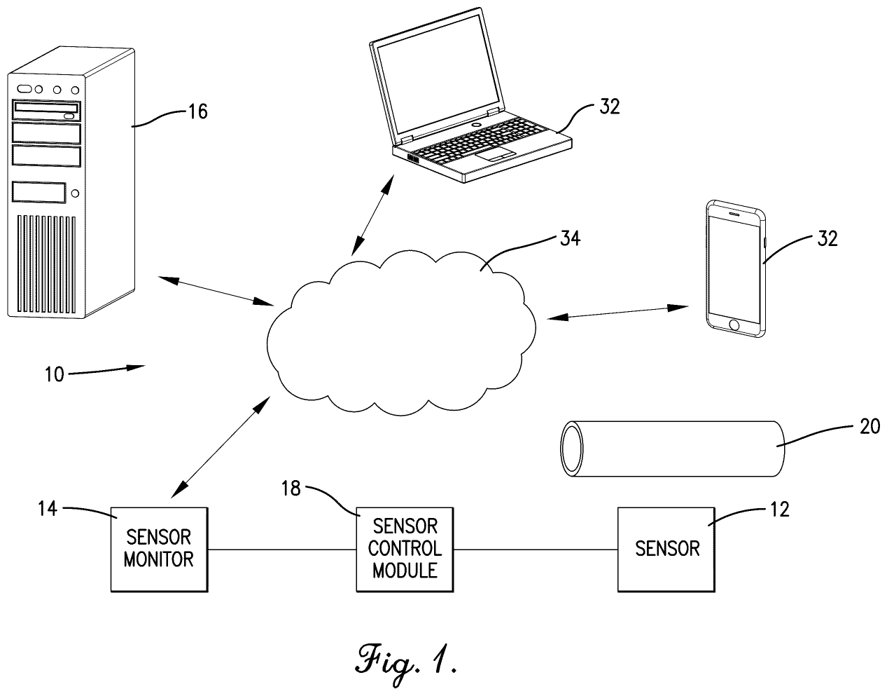

A leak detection system 10 particularly suited for detecting liquid leaks is depicted in FIG. 1 and broadly comprises at least one sensor 12; a sensor monitor 14; and a web-enabled remote computer 16.

The sensor 12 may be any liquid sensor that senses the presence of a liquid, the level of a liquid, or any other parameter that may indicate a liquid leak. The sensor 12 may include an attached or integrated sensor control module 18 that receives excitation signals from the sensor monitor 14 as described below and that generates return sensor signals proportional to liquids detected by the sensor. The sensor 12 and its sensor control module 18 may, for example, be selected and calibrated to output a sensor signal of 4-20 mA, 0-5 VDC, or 0-10 VDC that is proportional to a logical sensor range of 0 - 10 gallons per minute (GPM) or any other volume per time interval.

The sensor 12 may be placed anywhere, such as near a monitored pipe 20, tank, etc., and does not need a separate source of power other than the excitation signal. In one embodiment, the sensor is a poly absorptive sensor, also known as polymer absorption (PA) sensor. PA sensors detect hydrocarbons by absorbing them and expanding in the process. PA sensors are made of an elastomeric polymer matrix with embedded conducting particles and are deposited between electrodes on a printed circuit board (PCB). When hydrocarbons come into contact with the sensor, the matrix expands, which increases the distance between the conducting particles and changes the sensor's baseline resistance. Other types of sensors that are suitable for some applications include polymer-filled sensors, conducting polymer sensors, and poly(N-isopropylacrylamide) (PNIPAM) sensors.

The sensor monitor 14 powers and monitors the sensor 12 and its sensor control module 18 and wirelessly communicates with the remote computer 16. In some embodiments, a single sensor monitor 14 may monitor multiple sensors.

In one embodiment, the sensor monitor 14 periodically sends a 24 VDC excitation signal to the sensor control module 18, receives a 4-20 mA return sensor signal from the sensor control module that is proportional to an amount of gas or liquid sensed by the sensor 12, and transmits data representative of the sensor signal to the remote computer 16. In some embodiments, the sensor monitor receives user-specified alarm threshold values from the remote computer and only transmits sensor signals to the remote computer when the sensed gas or liquid exceeds the alarm threshold values. The frequency at which the sensor monitor excites the sensor, the frequency at which the sensor monitor communicates with the remote computer, and the alarm threshold values may be selected by a user and controlled via instructions sent from the remote computer to the sensor monitor.

The sensor monitor 14 can be implemented with hardware, software, firmware, or a combination thereof. Selected components of an exemplary sensor monitor 14 are illustrated in FIG. 3 and include a controller 22, memory 24, a communications device 26, and a power source 28. In one particular embodiment, the sensor monitor is an Elecsys SentraLink LD leak detection monitoring system.

The controller 22 may comprise or include any number or combination of processors, controllers, ASICs, computers, control circuitry, or any other logic devices. Likewise, the memory 24 may be any electronic memory that can be accessed by the controller 22 and operable for storing instructions or data. The memory 24 may be integral with the controller 22 or may be external memory accessible by the controller. The memory may be a single component or may be a combination of components that provide the requisite functionality. The memory may include various types of volatile or non-volatile memory such as flash memory, optical discs, magnetic storage devices, SRAM, DRAM, or other memory devices capable of storing data and instructions. The memory may communicate directly with the controller or may communicate over a bus or other mechanism that facilitates direct or indirect communication. The memory may optionally be structured with a file system to provide organized access to data existing thereon.

The communications device 26 may be any device that provides wireless communications between the sensor monitor and the remote computer. In a preferred embodiment, the communications device is a cellular or other radio transceiver, but it may also be a Bluetooth transceiver, a Wi-Fi transceiver, or satellite transceiver.

The power source 28 may be any external and/or internal source of electricity. For example, the power source may include an input port for coupling with an external source of electricity such as a 10-25VAC source, a 9-30 VDC source, or a 120 VAC outlet. The power source may also include an internal battery such as a primary lithium thionyl chloride battery and/or a solar panel.

Embodiments of the sensor monitor 14 may also comprise a GPS receiver 30 or other location-determining component so that the sensor monitor 14 can be quickly located. The sensor monitor may also include conventional input devices such as knobs, buttons, switches, dials, etc.; inputs for receiving programs and data from external devices; and/or one or more displays. Some or all of the components of the sensor monitor may be enclosed in or supported on a weatherproof housing for protection from moisture, vibration, and impact.

The above-described components of the sensor monitor 14 need not be physically connected to one another since wireless communication among the various depicted components is permissible and intended to fall within the scope of the present invention. Thus, portions of the sensor monitor may be located remotely from the sensor and from each other.

Embodiments of the remote computer 16 may include one or more servers running Windows; LAMP (Linux, Apache HTTP server, MySQL, and PHP/Perl/Python); Java; AJAX; NT; Novel Netware; Unix; or any other software system. The remote computer includes or has access to computer memory and other hardware and software for receiving, storing, accessing, and transmitting data and information as described below. The remote computer may also include conventional web hosting operating software, searching algorithms, an Internet connection, and is assigned a URL and corresponding domain name so that it can be accessed via the Internet in a conventional manner. In one particular embodiment of the invention, the remote computer employs data servers hosted on the Microsoft Azure Cloud.

The remote computer 16 wirelessly communicates with the sensor monitor 14 via a communications network 34 and provides a web portal for access by user operated smart phones, personal computers, or other web-enabled user devices 32. The web portal allows users to monitor pipes, tanks, etc. for liquid or gas leaks and provides “report by exception” monitoring and communication that sends instant text or email alerts to users if leaks are detected. This allows sensor excitation and reporting intervals to be longer to minimize communications and power usage.

In one embodiment, the remote computer 16 receives data representative of the sensor signals from the sensor monitor 14 and converts the sensor signals to logical sensor values such as parts-per-million (PPM), gallons-per-minute (GPM), or other volume per unit of time values so that users who access the remote computer or get notifications from the remote computer are presented with easy to understand sensor values. The remote computer may also receive alarm threshold values from users that are in the logical sensor values mentioned above, convert these logical sensor values to sensor signal values such as volts or amps, and then transmit data representative of the alarm threshold values to the sensor monitor. This relieves the sensor monitor from data conversion tasks to reduce its power usage and increase its data throughput speed.

The user-operated devices 32 may be smart phones, personal computers, or other web-enabled user devices. Each device includes or can access an Internet browser and a conventional Internet connection such as a wireless broadband connection, DSL converter, or ISDN converter so that it can exchange data with the remote computer 16 via the communications network 34. One or more of the devices may also exchange data directly with the sensor monitor 14 via Bluetooth, Wi-Fi, or other local network. The devices 32 may be operated by any persons or entities.

The communications network 34 may be the Internet or any other communications network such as a local area network, a wide area network, or an intranet. The communications network may include or be in communication with a wireless network capable of supporting wireless communications such as the wireless networks operated by AT&T, Verizon, or T-Mobile. The network may include conventional switching and routing equipment. The communications network and wireless network may also be combined or implemented with several different networks.

Aspects of the invention may be implemented with one or more computer programs stored in or on computer-readable medium residing on or accessible by the remote computer 16, the sensor monitor 14, and/or the user-operated devices 32. Each computer program preferably comprises an ordered listing of executable instructions for implementing logical functions. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The hardware and communication components illustrated and described herein are merely examples of equipment that may be used to implement embodiments of the present invention and may be replaced with other equipment without departing from the scope of the present invention. Some of the illustrated components may also be combined.

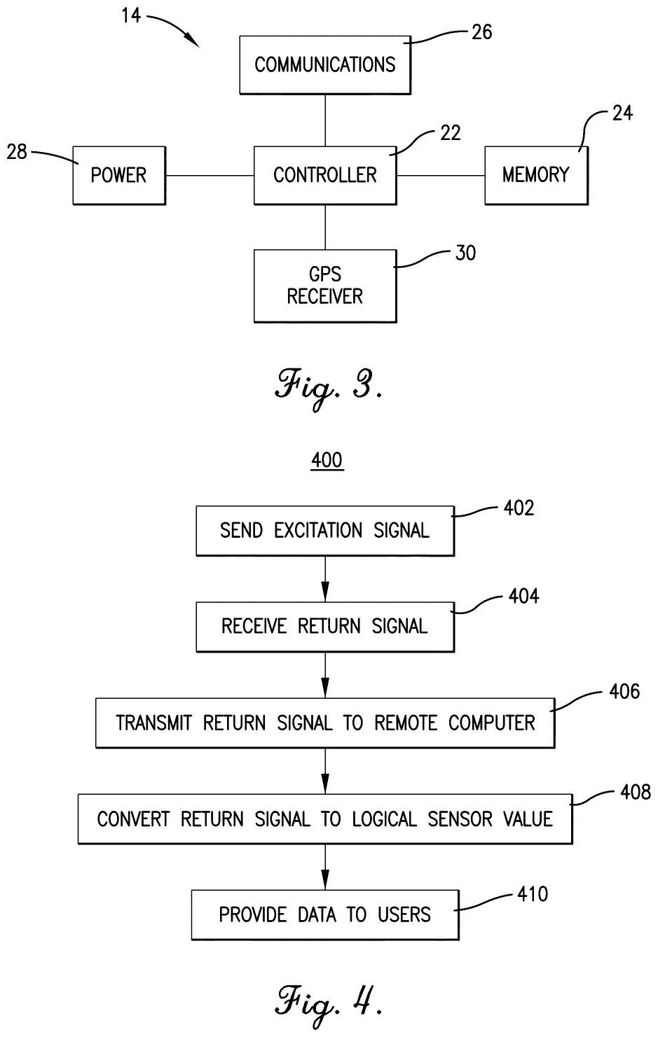

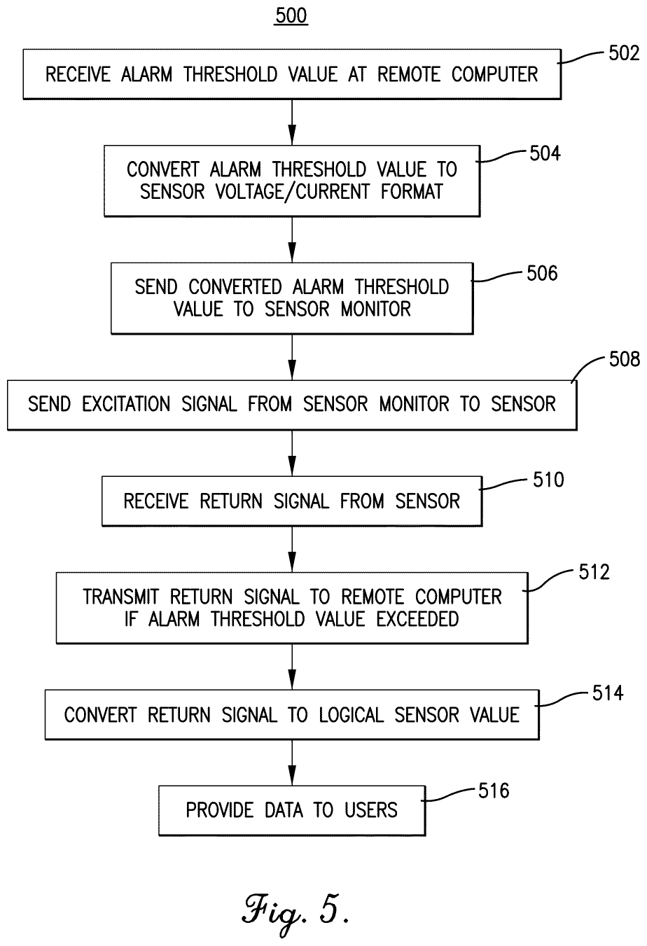

The flow charts of FIGS. 4 and 5 show the functionality and operation of implementations of the present invention in more detail. In this regard, some of the blocks of the flow charts may represent method steps and/or module segments or portions of code of the computer programs of the present invention. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

Turning first to FIG. 4, exemplary steps in a method 400 are illustrated. In one embodiment, the sensor monitor 14 sends an excitation signal to the sensor control module 18 as depicted in box 402. This energizes the sensor12, which together with the sensor control module, creates a return signal that is proportional to the amounts of liquid sensed by the sensor. The return sensor signal may be a 4-20 mA signal, 0-5 VDC signal, 0-10 VDC signal, or any other proportional current or voltage signal.

The sensor monitor 14 receives the return sensor signal as depicted in box 404 and transmits data representative of the sensor signal to the remote computer 16 as depicted in box 406. The remote computer converts the return signal to a logical sensor value such as gallons-per-minute (GPM) as depicted in box 408. The remote computer 16 permits users operating one of the user devices 32 to access a dashboard or other UI to read the logical sensor value as depicted in box 410. The remote computer may also push alerts and data to the user devices.

Turning now to FIG. 5, exemplary steps in another method 500 are illustrated. In one embodiment, the remote computer 16 receives an alarm threshold value from a user operating one of the user devices 32 as depicted in box 502. The received alarm threshold value is in a logical sensor value such as GPM. The remote computer then converts the logical sensor value to a sensor voltage/current format as depicted in box 504 and sends the converted alarm threshold to the sensor monitor as depicted in box 506. The remote computer may also receive sensor sampling intervals, reporting frequencies, and other control parameters from users in this same manner and transit data representative of these control parameters to the sensor monitor for remotely programming the sensor monitor.

Either according to a prescribed schedule or on demand, the sensor monitor 14 sends an excitation signal to the sensor control module as depicted in box 508. This energizes the sensor, which together with the sensor control module, creates a return signal that is proportional to the amounts of liquid sensed by the sensor. The return sensor signal may be a 4-20 mA signal, 0-5 VDC signal, 0-10 VDC signal, or any other proportional current or voltage signal.

The sensor monitor 14 then receives the return sensor signal as depicted in box 510 and compares it to the alarm threshold value. If the sensor signal exceeds the alarm threshold, the sensor monitor transmits data representative of the signal to the remote computer as depicted in box 512. The remote computer converts the return signal to a logical sensor value such as gallons-per-minute (GPM) as depicted in box 514 and permits users operating one of the user devices to access a dashboard or other UI to read the logical sensor value as depicted in box 516. The remote computer may also push alerts and data to the user devices and create reports of measured values, time/date stamps, site locations, etc. and provide such information either on a push or pull basis.

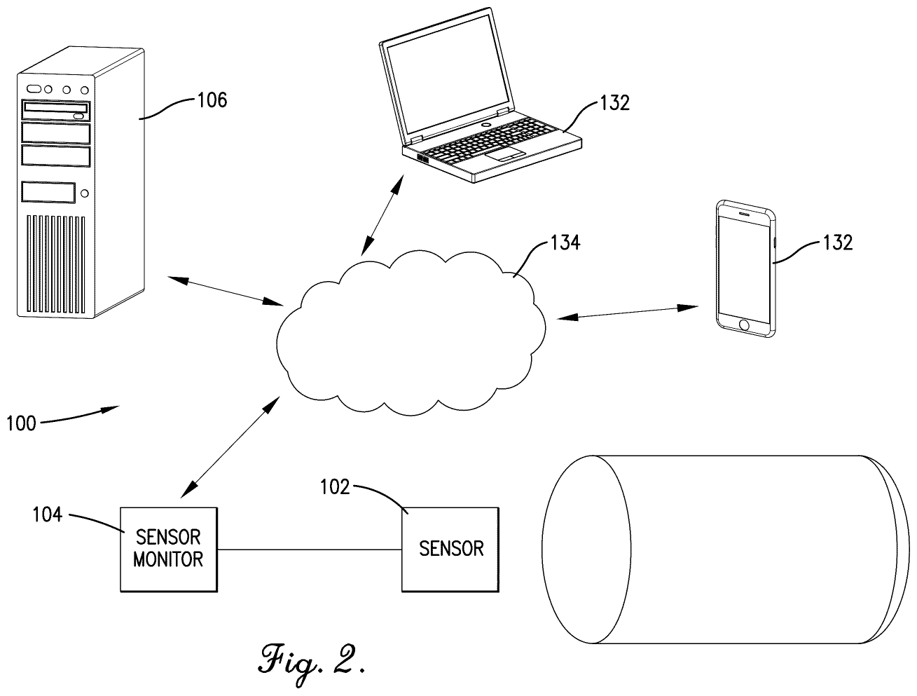

A leak detection system 100 constructed in accordance with another embodiment of the invention is depicted in FIG. 2. The leak detection system 100 is particularly suited for detecting gas leaks and broadly comprises at least one sensor 102; a sensor monitor 104; and a web-enabled remote computer 106. The system 100 operates the same as the system 10 except that the sensor 102 is a toxic gas sensor. The sensor may be an electrochemical sensor, an infrared sensor, a catalytic bead sensor, a photoionization detector, or any other suitable gas sensor. In one particular embodiment, the sensor monitor 104 is an Elecsys SentraLink LT leak detection monitoring system.

### Additional Considerations

The detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The detailed description is, therefore, not to be taken in a limiting sense. The scope of the current invention is defined only by the appended claims, along with the full scope of equivalents to which such claims are entitled.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for”or “step for”language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A leak detection system comprising:
a sensor for sensing a gas or liquid near the sensor;
a sensor monitor coupled with the sensor and operable to:
send an excitation signal to the sensor,
receive from the sensor a return signal that is proportional to an amount of gas or liquid sensed by the sensor, and
transmit data representative of the return signal; and
a remote computer in wireless communication with the sensor monitor and operable to:
receive the data representative of the return signal from the sensor monitor;
convert the data representative of the return signal to data representative of a logical sensor value; and
provide access to a web-enabled device operated by a user so the user may view the data representative of the logical sensor value.

2. The leak detection system of claim 1, wherein excitation signal is a 24 VDC signal.

3. The leak detection system of claim 1, wherein the return signal is a 0-5 VDC signal.

4. The leak detection system of claim 1, wherein the return signal is a 0-10 VDC signal.

5. The leak detection system of claim 1, wherein the return signal is a 4-20 mA signal.

6. The leak detection system of claim 1, wherein the logical sensor value is a parts per-million (PPM) value or volume per unit of time value.

7. The leak detection system of claim 1, wherein the remote computer is further operable to receive a threshold alarm level in a logical sensor value from the user via the web-enabled device, convert the threshold alarm level to a voltage or current format, and transmit data representative of the threshold alarm level to the sensor monitor.

8. The leak detection system of claim 7, wherein the sensor monitor is further operable to receive the data representative of the threshold alarm level from the remote computer.

9. The leak detection system of claim 8, wherein the sensor monitor is operable to send an excitation signal to the sensor, receive from the sensor a return signal, and transmit data representative of the return signal to the remote computer periodically according to a prescribed schedule.

10. The leak detection system of claim 8, wherein the sensor monitor is operable to send an excitation signal to the sensor and receive from the sensor a return signal periodically according to a prescribed schedule and to transmit data representative of the return signal to the remote computer only if the return signal exceeds the threshold alarm value.

11. The leak detection system of claim 9, wherein the remote computer is further operable to receive data representative of the prescribed schedule from the user via the web-enabled device and to transmit the data representative of the prescribed schedule to the sensor monitor.

12. The leak detection system of claim 1, wherein the sensor is a poly-absorptive sensor.

13. The leak detection system of claim 1, wherein the sensor is a catalytic diffusion sensor, infrared sensor, electromechanical gas sensor, thermal conductivity sensor, or ultraviolet sensor.

14. A method of detecting a gas or liquid leak, the method comprising:
sending an excitation signal to a sensor,
receiving from the sensor a return signal that is proportional to an amount of gas or liquid sensed by the sensor;
transmitting data representative of the return signal to a remote computer;
converting, with the remote computer, the data representative of the return signal to data representative of a logical sensor value; and
providing access to the remote computer by a web-enabled device operated by a user so the user may view the data representative of the logical sensor value.

15. The method of claim 14, wherein excitation signal is a 24 VDC signal.

16. The method of claim 14, wherein the return signal is a 0-5 VDC signal, a 0-10 VDC signal, or a 4-20 mA signal.

17. The method of claim 14, wherein the logical sensor value is a parts-per-million (PPM) value or volume per unit of time value.

18. The method of claim 14, further comprising, receiving a threshold alarm level at the remote computer from the user via the web-enabled device, converting the threshold alarm level to a voltage or current format, and transmitting data representative of the converted threshold alarm level to the sensor monitor.

19. The method of claim 14, wherein the sending, receiving, and transmitting steps data are performed periodically according to a prescribed schedule.

20. The method of claim 18, wherein the sending and receiving steps are performed periodically according to a prescribed schedule and the transmitting step is performed only if the return signal exceeds the threshold alarm level.
